(19) United States
(12) Patent Application Publication
(10) Pub. No.: US 2019/0056095 A1
(43) Pub. Date: Feb. 21, 2019

(54) LIGHTING DEVICE

(71) Applicant: CHICONY POWER TECHNOLOGY CO., LTD., New Taipei City (TW)

(72) Inventor: Zong-Lin LI, New Taipei City (TW)

(21) Appl. No.: 15/788,243

(22) Filed: Oct. 19, 2017

(30) Foreign Application Priority Data
Aug. 16, 2017 (TW) 106127701

(51) Int. Cl. F21V 21/26; F21V 23/00; F21V 21/22; F21V 17/12; F21V 1/02

(52) U.S. Cl. CPC F21V 21/26; F21V 23/002; F21V 1/02; F21V 17/12; F21V 21/22

(57) ABSTRACT

A lighting device includes a light emitting unit, a first hollow tube, a second hollow tube, multiple brackets, multiple supports, and a wire. The first hollow tube has a first pivot portion. The second hollow tube has a second pivot portion and is mounted around the first hollow tube. A first end of at least one bracket is pivotally connected to the first pivot portion. A first end of at least one support is pivotally connected to the second pivot portion. The wire passes through the first hollow tube, and one end of the wire is electrically connected to the light emitting unit. A second end of at least one support is configured with a first connecting portion, a second end of at least one bracket is configured with a second connecting portion, and the first connecting portion is pivotally connected to the second connecting portion.

### CROSS REFERENCE TO RELATED APPLICATIONS

This Non-provisional application claims priority under 35 U.S.C. § 119(a) on Patent Application No(s). 106127701 filed in Taiwan, Republic of China on Aug. 16, 2017, the entire contents of which are hereby incorporated by reference.

### BACKGROUND

### Technology Field

The present disclosure relates to a lighting device with a lampshade that can be conveniently replaced, which is an economic and environmentally friendly application.

### Description of Related Art

The lampshade of the conventional hanging LED lamp must be designed to fit the LED lamp holder, so it cannot be used in other lighting devices. In other words, there is no flexible option for lampshade replacement. Thus, if the lampshade is broken, it is hard to buy a new lampshade to replace it. This design will cause the increase of manufacturing cost and is not economic and environmentally friendly.

Therefore, it is desired to provide a lighting device having a lampshade, which is not limited to the standard lampshade with originally designed shape and can be a recyclable implement (e.g. a bottle), so that the replacement of the lampshade can be economic and environmentally friendly.

### SUMMARY

An objective of the disclosure is to provide a lighting device having a lampshade, which is not limited to the standard lampshade with originally designed shape and can be a recyclable implement (e.g. a bottle), so that the replacement of the lampshade can be economic and environmentally friendly.

To achieve the above, the present disclosure provides a lighting device including a light emitting unit, a first hollow tube, a second hollow tube, a plurality of brackets, a plurality of supports, and a wire. The first hollow tube has a first pivot portion, and the second hollow tube has a second pivot portion. The second hollow tube is mounted around the first hollow tube. A first end of at least one of the brackets is pivotally connected to the first pivot portion, and a first end of at least one of the supports is pivotally connected to the second pivot portion. The wire passes through the first hollow tube. One end of the wire is electrically connected to the light emitting unit. A second end of at least one of the supports is configured with a first connecting portion, and a second end of at least one of the brackets is configured with a second connecting portion. The first connecting portion is pivotally connected to the second connecting portion.

In one embodiment, a length of the second hollow tube is less than a length of the first hollow tube, both the first hollow tube and the second hollow tube have a hole for disposing a limiting member, and the limiting member is configured to limit a movement of the second hollow tube.

In one embodiment, the second end of at least one of the brackets or at least one of the supports is configured with a slide-proof unit.

In one embodiment, the first connecting portion has a first pivoting hole or a first pivoting structure, and the second connecting portion has a second pivoting hole or a second pivoting structure.

In one embodiment, the first pivoting hole of the first connecting portion is pivotally connected to the second pivoting structure of the second connecting portion. In one embodiment, the first pivoting structure of the first connecting portion is pivotally connected to the second pivoting hole of the second connecting portion. In one embodiment, the first pivoting hole of the first connecting portion is pivotally connected to the second pivoting hole of the second connecting portion by a first shaft. In one embodiment, the first pivoting structure of the first connecting portion is pivotally connected to the second pivoting structure of the second connecting portion by a second shaft.

In addition, the present disclosure also provides a lighting device including a light emitting unit, a first hollow tube, a second hollow tube, a plurality of brackets, a plurality of through holes, and a wire. The first hollow tube has a pivot portion, and the second hollow tube is mounted around the first hollow tube. A first end of at least one of the brackets is pivotally connected to the pivot portion. The through holes are formed on the second hollow tube. The wire passes through the first hollow tube, and one end of the wire is electrically connected to the light emitting unit.

In one embodiment, the first hollow tube moves toward a first direction or the second hollow tube moves toward a second direction, so that a second end of at least one of the brackets protrudes beyond the second hollow tube through at least one of the through holes.

In one embodiment, an outer surface of the first hollow tube is configured with a first thread structure, an inner surface of the second hollow tube is configured with a second thread structure, and the first thread structure is detachably screwed to the second thread structure.

In one embodiment, both the first hollow tube and the second hollow tube have a hole for disposing a limiting member. The limiting member is configured to limit a movement of the second hollow tube, and a length of the second hollow tube is less than a length of the first hollow tube.

In one embodiment, a second end of at least one of the brackets is configured with a slide-proof unit.

As mentioned above, the lighting device of this disclosure is designed with the first hollow tube, the second hollow tube, the brackets, the supports, and the through holes, so that the lampshade for the lighting device is not limited to the standard lampshade with originally designed shape. In practice, it is possible to use a recyclable implement (e.g. a bottle) as the lampshade. This feature makes the replacement of the lampshade become more economic and environmentally friendly.

### BRIEF DESCRIPTION OF THE DRAWINGS

The disclosure will become more fully understood from the detailed description and accompanying drawings, which are given for illustration only, and thus are not limitative of the present disclosure, and wherein:

FIGS. 1A and 1B are schematic diagrams showing a lighting device according to a first embodiment of the disclosure;

FIGS. 2A and 2B are schematic diagrams showing another aspect of the lighting device according to the first embodiment of the disclosure;

FIG. 3 is a schematic diagram showing another aspect of the lighting device according to the first embodiment of the disclosure;

FIGS. 4A to 4D are schematic diagrams showing different aspects of the bracket and the support according the first embodiment of the disclosure;

FIGS. 5A and 5B are schematic diagrams showing a lighting device according to a second embodiment of the disclosure; and

FIGS. 6A and 6B are schematic diagrams showing another aspect of the lighting device according to the second embodiment of the disclosure.

### DETAILED DESCRIPTION OF THE DISCLOSURE

The present disclosure will be apparent from the following detailed description, which proceeds with reference to the accompanying drawings, wherein the same references relate to the same elements.

The lighting device of this disclosure is not limited to use the standard lampshade. For example, it is possible to use a recyclable implement (e.g. a bottle) as the lampshade. This feature makes the replacement of the lampshade become more economic and environmentally friendly.

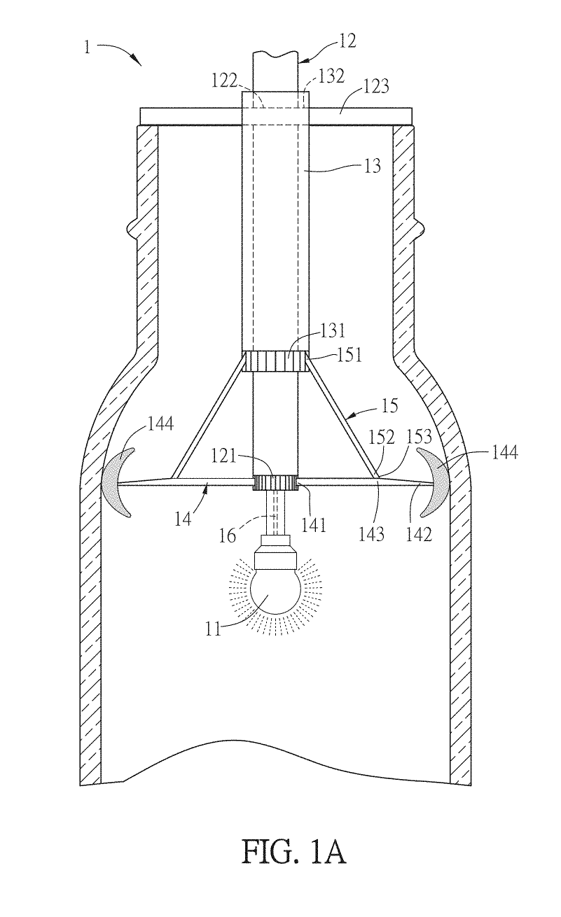

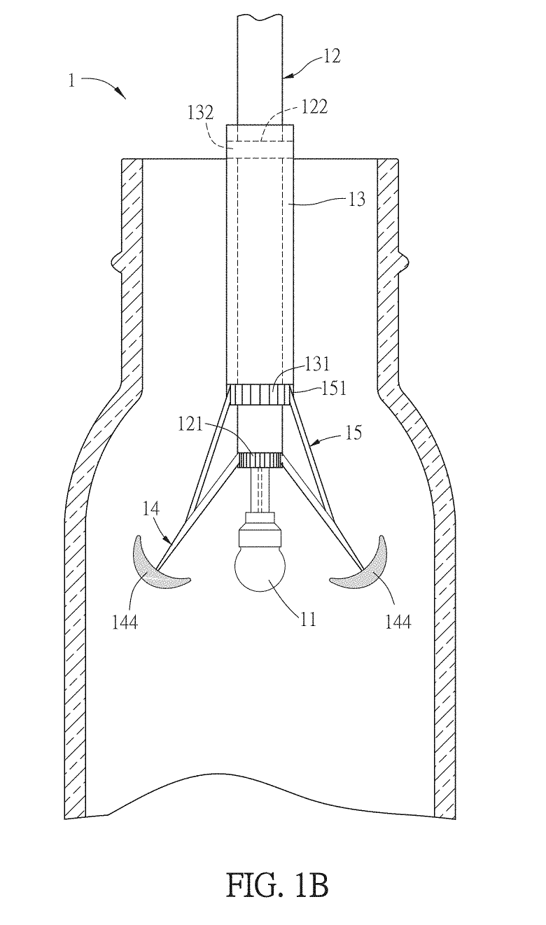

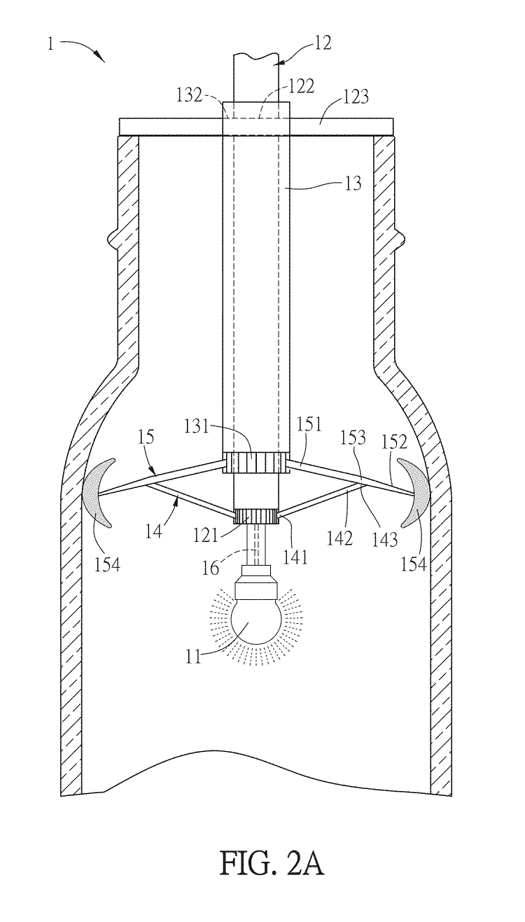

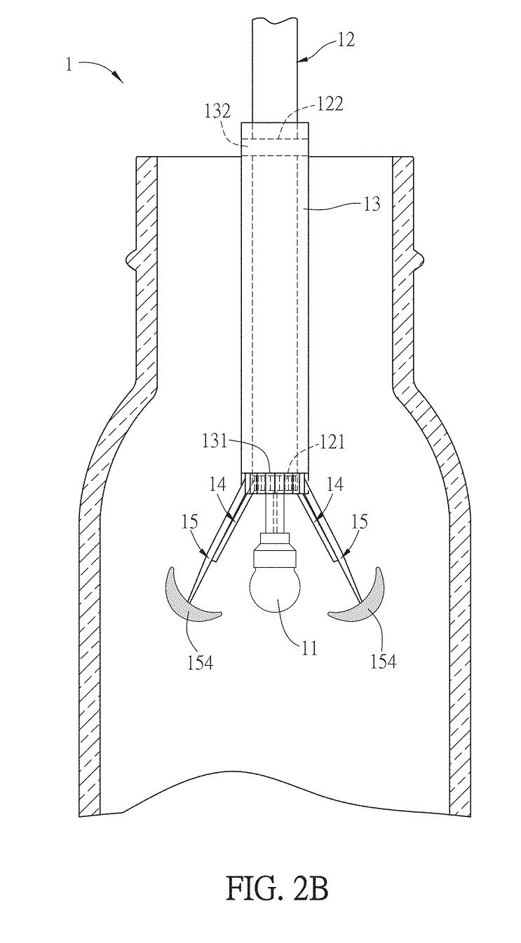

FIGS. 1A, 1B, 2A and 2B are schematic diagrams of a lighting device 1 according to a first embodiment of the disclosure. The lighting device 1 includes a light emitting unit 11, a first hollow tube 12, a second hollow tube 13, a plurality of brackets 14, a plurality of supports 15, and a wire 16.

The first hollow tube 12 has a first pivot portion 121. The second hollow tube 13 has a second pivot portion 131. The second hollow tube 13 is mounted around the first hollow tube 12. A first end 141 of at least one of the brackets 14 is pivotally connected to the first pivot portion 121, and a first end 151 of at least one of the supports 15 is pivotally connected to the second pivot portion 131. The wire 16 passes through the first hollow tube 12. One end of the wire 16 is electrically connected to the light emitting unit 11. A second end 152 of at least one of the supports 15 is configured with a first connecting portion 153, and a second end 142 of at least one of the brackets 14 is configured with a second connecting portion 143. The first connecting portion 153 is pivotally connected to the second connecting portion 143.

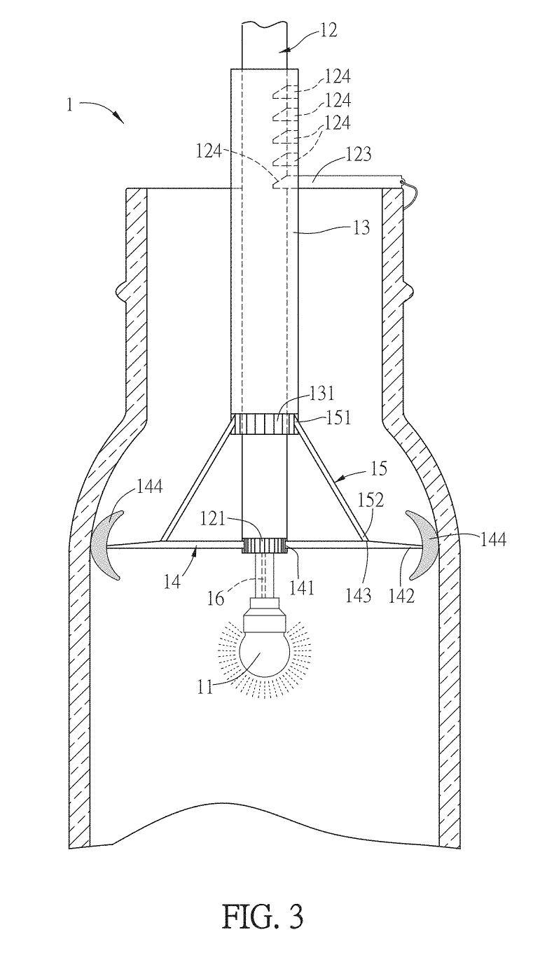

Referring to FIGS. 1A, 1B, 2A and 2B, a length of the second hollow tube 13 is less than a length of the first hollow tube 12. The first hollow tube 12 has a hole 122, and the second hollow tube 13 has a hole 132. The holes 122 and 132 are configured for disposing a limiting member 123, and the limiting member 123 is configured to limit a movement of the second hollow tube 13. Alternatively, as shown in FIG. 3, the first hollow tube 12 includes a plurality of slots 124 instead of the hole 122. The slots 124 are configured to engage with the limiting member 123 for limiting a movement of the second hollow tube 13.

The second end 142 of at least one of the brackets 14 is configured with a slide-proof unit 144 (see FIGS. 1A, 1B and 3). Alternatively, the second end 152 of at least one of the supports 15 is configured with a slide-proof unit 154 (see FIGS. 2A and 2B).

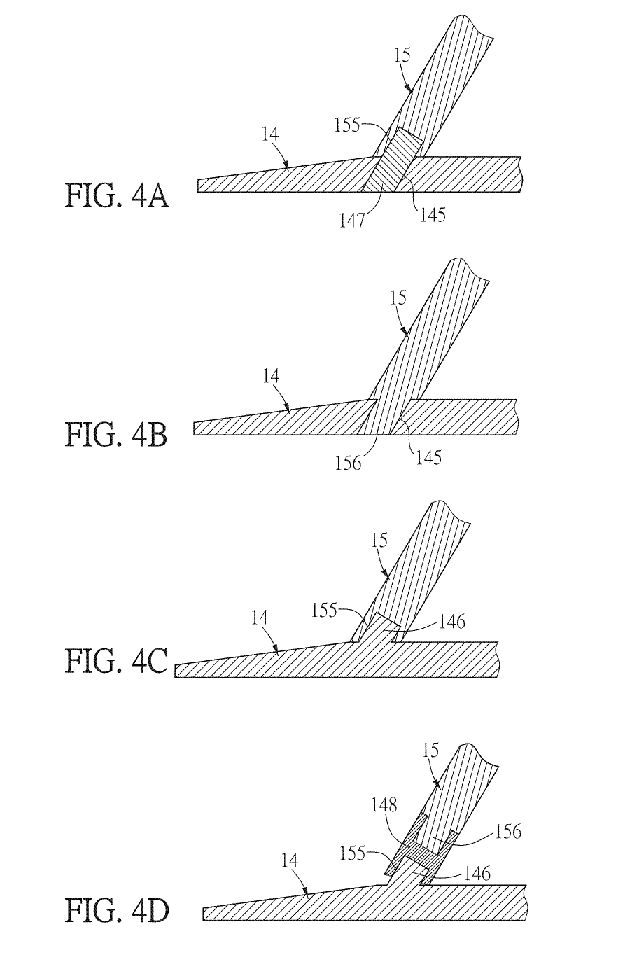

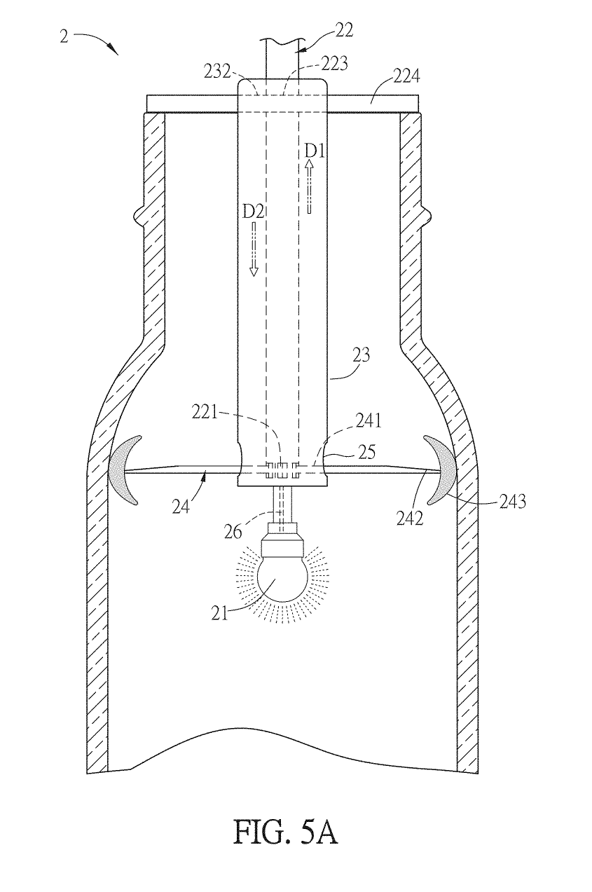

FIGS. 4A to 4D are schematic diagrams showing different aspects of the bracket 14 and the support 15 according the first embodiment of the disclosure. As shown in FIGS. 1A, 1B and 4A to 4D, the first connecting portion 153 has a first pivoting hole 155 or a first pivoting structure 156, and the second connecting portion 143 has a second pivoting hole 145 or a second pivoting structure 146.

In one aspect, as shown in FIG. 4C, the first pivoting hole 155 of the first connecting portion 153 is pivotally connected to the second pivoting structure 146 of the second connecting portion 143. In one aspect, as shown in FIG. 4B, the first pivoting structure 156 of the first connecting portion 153 is pivotally connected to the second pivoting hole 145 of the second connecting portion 143. In one aspect, as shown in FIG. 4A, the first pivoting hole 155 of the first connecting portion 153 is pivotally connected to the second pivoting hole 145 of the second connecting portion 143 by a first shaft 147. In one aspect, as shown in FIG. 4D, the first pivoting structure 156 of the first connecting portion 153 is pivotally connected to the second pivoting structure 146 of the second connecting portion 143 by a second shaft 148.

While installing the lighting device 1, the user can use a recyclable implement (e.g. a bottle) as the lampshade. The light emitting unit 11 electrically connected to the wire 16, the first hollow tube 12, the second hollow tube 13, the brackets 14 and the supports 15 are together passing through the bottle mouth and are then disposed inside the bottle. Next, the second hollow tube 13 is pushed to make the brackets 14 and the supports 15 spread outwardly until the second ends 142 or the slide-proof units 144 of the brackets 14 butt against the inner surface of the bottle. Finally, the limiting member 123 is installed to fix the second hollow tube 13 and prevent it from moving back. As shown in FIGS. 1A and 1B, the lighting device 1 can be easily installed. Due to the friction force between the inner surface of the bottle and the second ends 142 or the slide-proof units 144 of the brackets 14, the bottle can be hold and will not fall down (see FIGS. 1A and 1B). Alternatively, The light emitting unit 11 electrically connected to the wire 16, the first hollow tube 12, the second hollow tube 13, the brackets 14 and the supports 15 are together pass through the bottle mouth and are then disposed inside the bottle. Next, the second hollow tube 13 is pushed to make the brackets 14 and the supports 15 spread outwardly until the second ends 152 or the slide-proof units 154 of the supports 15 butt against the inner surface of the bottle. Finally, the limiting member 123 is installed to fix the second hollow tube 13 and prevent it from moving back. As shown in FIGS. 2A and 2B, the lighting device 1 can be easily installed. Due to the friction force between the inner surface of the bottle and the second ends 152 or the slide-proof units 154 of the supports 15, the bottle can be hold and will not fall down (see FIGS. 2A and 2B). In addition, the user can remove the limiting member 123 and pull the second hollow tube 13 back toward the bottom mouth. Then, the brackets 14 and the supports 15 can be folded, and the lighting device 1 can be moved out of the bottle.

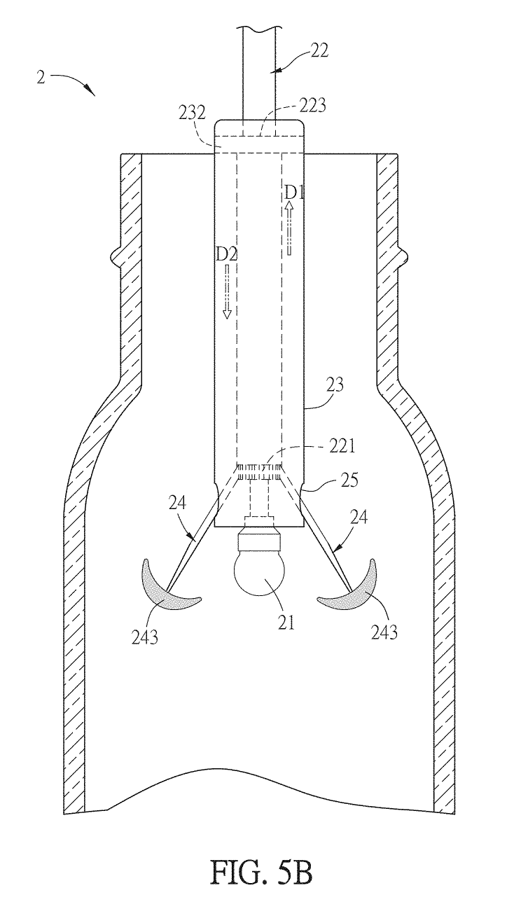

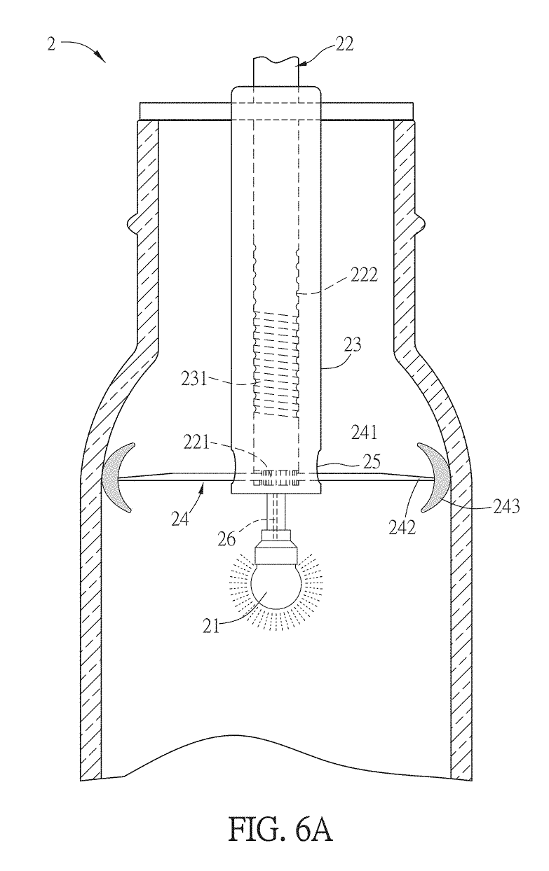

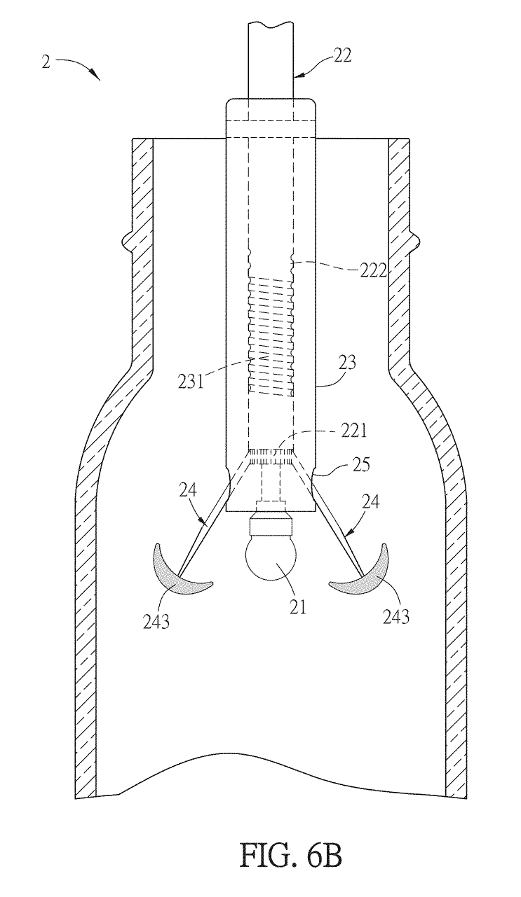

FIGS. 5A, 5B, 6A and 6B are schematic diagrams showing a lighting device 2 according to a second embodiment of the disclosure. The lighting device 2 includes a light emitting unit 21, a first hollow tube 22, a second hollow tube 23, a plurality of brackets 24, a plurality of through holes 25, and a wire 26. The first hollow tube 22 has a pivot portion 221, and the second hollow tube 23 is mounted around the first hollow tube 22. A first end 241 of at least one of the brackets 24 is pivotally connected to the pivot portion 221. The through holes 25 are formed on the second hollow tube 23. The wire 26 passes through the first hollow tube 22, and one end of the wire 26 is electrically connected to the light emitting unit 21.

In this embodiment, the first hollow tube 22 moves toward a first direction D1 or the second hollow tube 23 moves toward a second direction D2, so that a second end 242 of at least one of the brackets 24 protrudes beyond the second hollow tube 23 through at least one of the through holes 25.

In this embodiment, an outer surface of the first hollow tube 22 is configured with a first thread structure 222, and an inner surface of the second hollow tube 23 is configured with a second thread structure 231. The first thread structure 222 can be detachably screwed to the second thread structure 231 (see FIGS. 6A and 6B). Alternatively, the first hollow tube 22 has a hole 223, and the second hollow tube 23 has a hole 232. Similar to the first embodiment, the holes 223 and 232 are configured to dispose a limiting member 224, and the limiting member 224 is configured to limit the movement of the second hollow tube 23 (see FIGS. 5A and 5B). The length of the second hollow tube 23 is less than the length of the first hollow tube 22. The second end 242 of at least one of the brackets 24 is configured with a slide-proof unit 243.

While installing the lighting device 2, the user can use a recyclable implement (e.g. a bottle) as the lampshade. The light emitting unit 21 electrically connected to the wire 26, the first hollow tube 22, the second hollow tube 23 and the brackets 24 protruding beyond the holes 25 are together passing through the bottle mouth and are then disposed inside the bottle. Next, the second hollow tube 23 is pushed and moved toward the second direction D2 so as to make the brackets 24 spread outwardly until the second ends 242 or the slide-proof units 243 of the brackets 24 butt against the inner surface of the bottle. Finally, the limiting member 224 is installed to fix the second hollow tube 23 and prevent it from moving back. Alternatively, the first thread structure 222 can be screwed into the second thread structure 231 for fixing the second hollow tube 23. As shown in FIGS. 5A, 5B, 6A and 6B, the lighting device 2 can be easily installed. Due to the friction force between the inner surface of the bottle and the second ends 242 or the slide-proof units 243 of the brackets 24, the bottle can be hold and will not fall down. In addition, the user can remove the limiting member 224 and pull the second hollow tube 23 back toward the bottom mouth so as to remove the lighting device 2 from the bottle. Alternatively, the user can rotate the first thread structure 222 for detaching it from the second thread structure 231, and then move the lighting device 2 out of the bottle.

In summary, the lighting device of this disclosure is designed with the first hollow tube, the second hollow tube, the brackets, the supports, and the through holes, so that the lighting device is not limited to use the standard lampshade with originally designed shape. In practice, it is possible to use a recyclable implement (e.g. a bottle) as the lampshade. This feature makes the replacement of the lampshade become more economic and environmentally friendly.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A lighting device, comprising:
a light emitting unit;
a first hollow tube having a first pivot portion;
a second hollow tube having a second pivot portion and mounted around the first hollow tube;
a plurality of brackets, wherein a first end of at least one of the brackets is pivotally connected to the first pivot portion;
a plurality of supports, wherein a first end of at least one of the supports is pivotally connected to the second pivot portion; and
a wire passing through the first hollow tube, wherein one end of the wire is electrically connected to the light emitting unit, a second end of at least one of the supports is configured with a first connecting portion, a second end of at least one of the brackets is configured with a second connecting portion, and the first connecting portion is pivotally connected to the second connecting portion.

2. The lighting device according to claim 1, wherein a length of the second hollow tube is less than a length of the first hollow tube, both the first hollow tube and the second hollow tube have a hole for disposing a limiting member, and the limiting member is configured to limit a movement of the second hollow tube.

3. The lighting device according to claim 1, wherein the second end of at least one of the brackets or at least one of the supports is configured with a slide-proof unit.

4. The lighting device according to claim 1, wherein the first connecting portion has a first pivoting hole or a first pivoting structure, and the second connecting portion has a second pivoting hole or a second pivoting structure.

5. The lighting device according to claim 4, wherein the first pivoting hole of the first connecting portion is pivotally connected to the second pivoting structure of the second connecting portion; or the first pivoting structure of the first connecting portion is pivotally connected to the second pivoting hole of the second connecting portion; or the first pivoting hole of the first connecting portion is pivotally connected to the second pivoting hole of the second connecting portion by a first shaft; or the first pivoting structure of the first connecting portion is pivotally connected to the second pivoting structure of the second connecting portion by a second shaft.

6. A lighting device, comprising:
a light emitting unit;
a first hollow tube having a pivot portion;
a second hollow tube mounted around the first hollow tube;
a plurality of brackets, wherein a first end of at least one of the brackets is pivotally connected to the pivot portion;
a plurality of through holes formed on the second hollow tube; and
a wire passing through the first hollow tube, wherein one end of the wire is electrically connected to the light emitting unit.

7. The lighting device according to claim 6, wherein the first hollow tube moves toward a first direction or the second hollow tube moves toward a second direction, so that a second end of at least one of the brackets protrudes beyond the second hollow tube through at least one of the through holes.

8. The lighting device according to claim 7, wherein an outer surface of the first hollow tube is configured with a first thread structure, an inner surface of the second hollow tube is configured with a second thread structure, and the first thread structure is detachably screwed to the second thread structure.

9. The lighting device according to claim 6, wherein both the first hollow tube and the second hollow tube have a hole for disposing a limiting member, the limiting member is configured to limit a movement of the second hollow tube, and a length of the second hollow tube is less than a length of the first hollow tube.

10. The lighting device according to claim 6, wherein a second end of at least one of the brackets is configured with a slide-proof unit.
